(19) United States
(12) Patent Application Publication
(10) Pub. No.: US 2012/0308068 A1
(43) Pub. Date: Dec. 6, 2012

(54) HEAD MULTI-DIRECTIONAL AUDIO DEVICE

(76) Inventors: Yueh-Hua Hsu Huang, New Taipei City (TW); Wen-Chuan Hsu, New Taipei City (TW); Chun-Ti Chen, New Taipei City (TW)

(21) Appl. No.: 13/153,080

(22) Filed: Jun. 3, 2011

(51) Int. Cl. H04R 25/00

(52) U.S. Cl. 381/374

(57) ABSTRACT

A head multi-directional audio device comprises: a head-wear member, which has two broadcasting devices, one buffer structure and two folding portions, the two broadcasting devices are with two sounding portions at the two external sides thereof, the two broadcasting devices are extended toward the right hand side and left hand side of the head-wear member individually, wherein the folding portion lets the broadcasting device, extended from the head-wear member, be bent inwardly; and two shelters, each has four braces that are to support the shelter on the two sounding portions, at least one sound exit is among the four braces on the each sounding portion, so that the sound from the sounding portion can be broadcasted by the sound exit.

### BACKGROUND OF THE INVENTION

1. Field of the Invention

The present invention generally relates to a head multi-directional audio device, more particularly to a head wearing audio device that is to broadcast sound outwardly.

2. Description of the Prior Art

Nowadays, a general earphone broadcasts sound from the internal thereof to surrounding through the internal speakers, and there are normally two types of earphone: one is ear wearing and the other is head wearing. Ear-wearing earphone is worn in the outline of an ear directly, and it is very close to the tympanum of the ear, and the soft tissue of the ears may be damaged while in a long-time wearing; on the other hand, head-wearing earphone may not directly damage the tympanum of the ear so as to decrease the possibility of hurting the ear tympanum, but such earphone is usually in large size and not convenient to be carried. Hence, for the personally portable demands, the head-wearing earphone does not conform to the flexibility and mobility.

Aforesaid ear-wearing earphone and head-wearing earphone have their advantages and disadvantages, however, both of them make sound directly toward ears, thus the ears are sheltered while in use of the earphones. So as it may cause that the user cannot concentrate his or her mind and reduces the sensitivity to things around, and ignore warning sound and bring about accident.

As a conclusion, to produce a head multi-directional audio device that is to broadcast sound outwardly shall be the best solution.

### SUMMARY OF THE INVENTION

The main objective of the present invention is to provide a head multi-directional audio device that is able to let sound be broadcasted outwardly so as to avoid the earphones directly toward user's ears and hurting the ears or causing user not concentrating his or her mind situation.

To achieve above objective, the head multi-directional audio device includes: a head-wear member 1, which has two broadcasting devices 11, one buffer structure 12 and two folding portions 13, the two broadcasting devices 11 are extended toward the right hand side and left hand side of the head-wear member 1 individually and are bent inwardly, the two broadcasting devices 11 are with two sounding portions 1111 at the two external sides thereof; two shelters 2, each has four braces 21 that are to support the shelter 2 on the two sounding portions 1111, at least one sound exit 23 is among the four braces 21 on the each sounding portion 1111, so that the sound from the sounding portion 1111 can be broadcasted by the sound exit 23, on the other hand, the sounding portion 4111 has a baffle structure 412 as well, thus the sound from the sounding portion 4111 can be reflected downwardly to output by the baffle structure 412. While the user 3 wears the head multi-directional audio device, the user can hear the sound from the sounding portions and avoid that the user not concentrating his or her mind, or damaging the ear hearing by using earphones.

Preferably, the folding portion 13 has a pivot 131 inside in order to let the broadcasting device 11, extended from the head-wear member 1, be bent and adjusted angle inwardly, and the head multi-directional audio device with a function of completely and inwardly bending can be disposed on a surface.

Preferably, the buffer structure 12 is able to accommodate a PCB and batteries (not shown in figure), the PCB and batteries are electrically connected with the broadcasting device 11.

Preferably, the buffer structure 12 is made of rubber material.

Preferably, the broadcasting device 11 has at least one speaker 111 inside.

Preferably, the broadcasting device 11 has a cushion portion 112 inwardly so as to make the broadcasting devices 11 be fit onto the side surface of the head of the user 3, and the cushion portion 112 is made of rubber material.

Preferably, the surface of the head-wear member 1 can be added a metal case.

Preferably, the surface of the broadcasting device 11 can be added a metal case.

Other and further features, advantages, and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits, and advantages of the preferred embodiments of the present invention will be readily understood by the accompanying drawings and detailed descriptions, wherein:

FIG. 1A illustrates a schematic 3-D structural view of a first preferred embodiment of the head multi-directional audio device of the present invention;

FIG. 1B illustrates a schematic 3-D folding view of the first preferred embodiment of the head multi-directional audio device of the present invention;

FIG. 2A illustrates a schematic 3-D exploding view of a broadcasting device of the first preferred embodiment of the head multi-directional audio device of the present invention;

FIG. 2B illustrates a schematic 3-D assembling view of the broadcasting device of the first preferred embodiment of the head multi-directional audio device of the present invention;

FIG. 3A illustrates a schematic cross view of the broadcasting device of the first preferred embodiment of the head multi-directional audio device of the present invention;

FIG. 3B illustrates a schematic sounding view of the broadcasting device of the first preferred embodiment of the head multi-directional audio device of the present invention;

FIG. 4 illustrates a schematic application view of the first preferred embodiment of the head multi-directional audio device of the present invention;

FIG. 5A illustrates a schematic 3-D structural view of a second preferred embodiment of the head multi-directional audio device of the present invention,

FIG. 5B illustrates a schematic 3-D folding view of the second preferred embodiment of the head multi-directional audio device of the present invention,

FIG. 6A illustrates a schematic cross view of a broadcasting device of the second preferred embodiment of the head multi-directional audio device of the present invention,

FIG. 6B illustrates a schematic sounding view of the broadcasting device of the second preferred embodiment of the head multi-directional audio device of the present invention, and

FIG. 7 illustrates a schematic application view of the second preferred embodiment of the head multi-directional audio device of the present invention.

### DETAILED DESCRIPTION OF THE INVENTION

Following preferred embodiments and figures will be described in detail so as to achieve aforesaid objects.

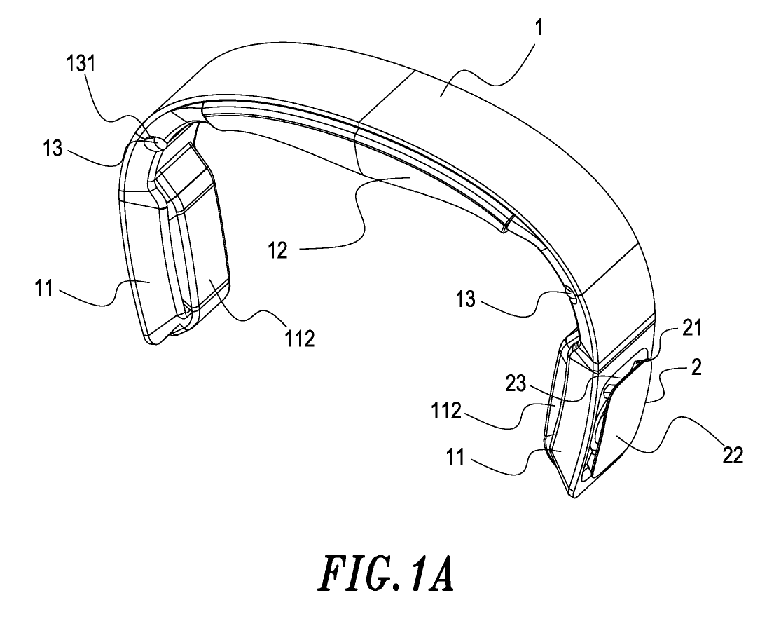

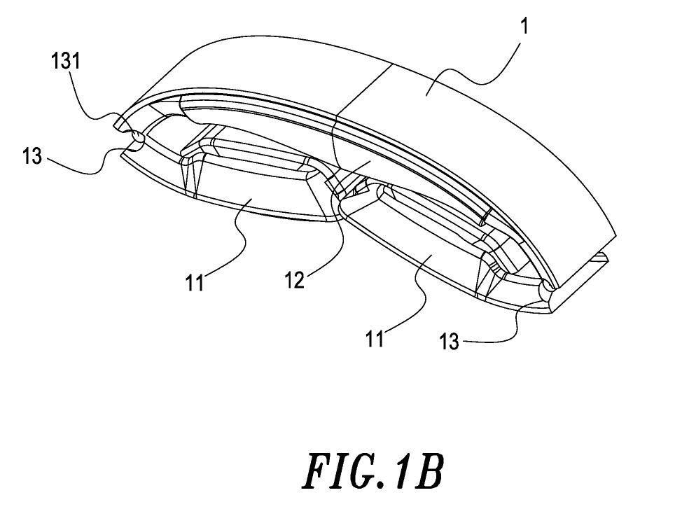

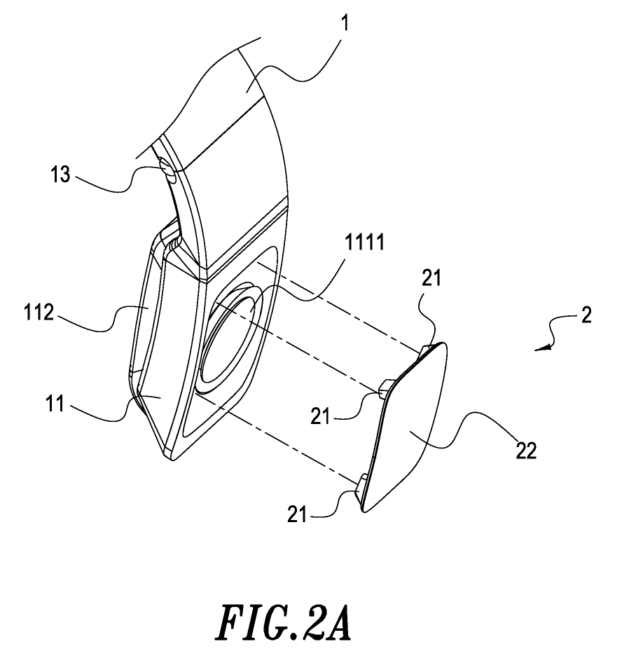

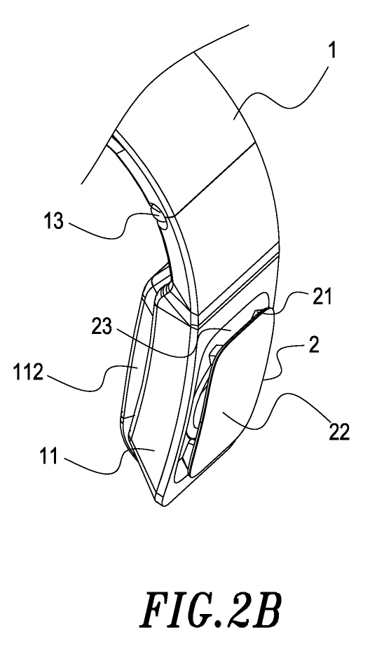

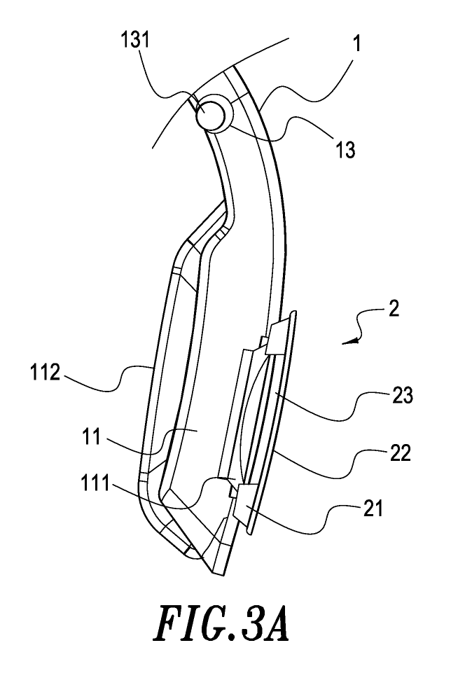

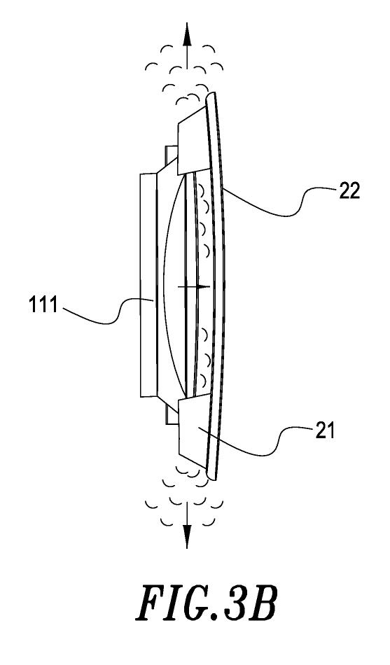

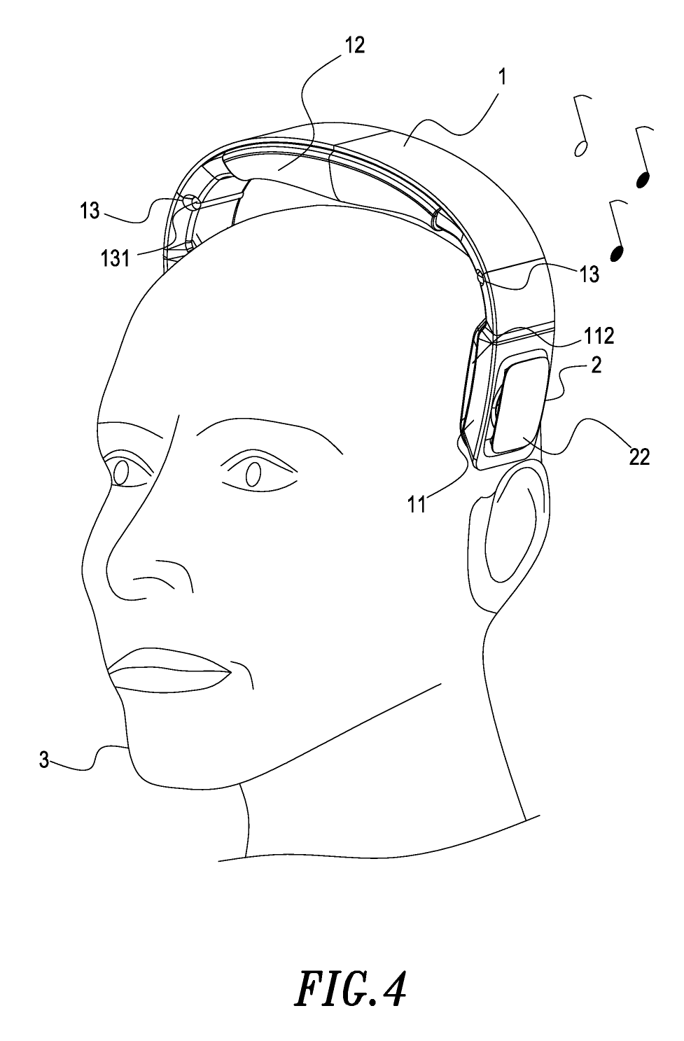

With references to FIG. 1A, FIG. 1B, FIG. 2A, FIG. 2B, FIG. 3A, FIG. 3B, and FIG. 4, showing the illustration of the first preferred embodiment of the head multi-directional audio device of the present invention, including a schematic 3-D structural view, a schematic 3-D folding view, a schematic 3-D exploding view of a broadcasting device, a schematic 3-D assembling view of the broadcasting device, a schematic cross view of the broadcasting device, a schematic sounding view of the broadcasting device, and a schematic application view. As shown in figures, the head multi-directional audio device includes:

a head-wear member 1, which has two broadcasting devices 11, one buffer structure 12 and two folding portions 13, the two broadcasting devices 11 are with two sounding portions 1111 at the two external sides thereof, the two broadcasting devices 11 are extended toward the right hand side and left hand side of the head-wear member 1 individually, wherein the folding portion 13 lets the broadcasting device 11, extended from the head-wear member 1, be bent inwardly;
two shelters 2, each has four braces 21 that are to support the shelter 2 on the two sounding portions 1111, at least one sound exit 23 is among the four braces 21 on the each sounding portion 1111, so that the sound from the sounding portion 1111 can be broadcasted by the sound exit 23.
While a user 3 wears the head multi-directional audio device (above his ears), the sound from the two sounding portions 1111 is blocked by the surfaces 22 of the shelters 2 so as to spread the sound to the surrounding via the sound exits 23. So that the user 3 can hear the sound from the two sounding portions 1111 of speakers 111 of the broadcasting devices 11 even if the two sounding portions 1111 are not toward the ears of the user 3.

Preferably, the folding portion 13 has a pivot 131 inside in order to let the broadcasting device 11, extended from the head-wear member 1, be bent an angle inwardly, and the head multi-directional audio device with a function of completely and inwardly bending can be disposed on a surface.

Preferably, the buffer structure 12 is able to accommodate a PCB and batteries (not shown in figure), the PCB and batteries are electrically connected with the broadcasting device 11.

Preferably, the buffer structure 12 is made of rubber material in order to let the user comfortably wear the head multi-directional audio device.

Preferably, the broadcasting device 11 has at least one speaker 111 inside.

Preferably, the broadcasting device 11 has a cushion portion 112 inwardly so as to make the broadcasting devices 11 be fit onto the side surface of the head of the user 3, and the cushion portion 112 is made of rubber material.

Preferably, the surface of the head-wear member 1 can be added a metal case (not shown in figure).

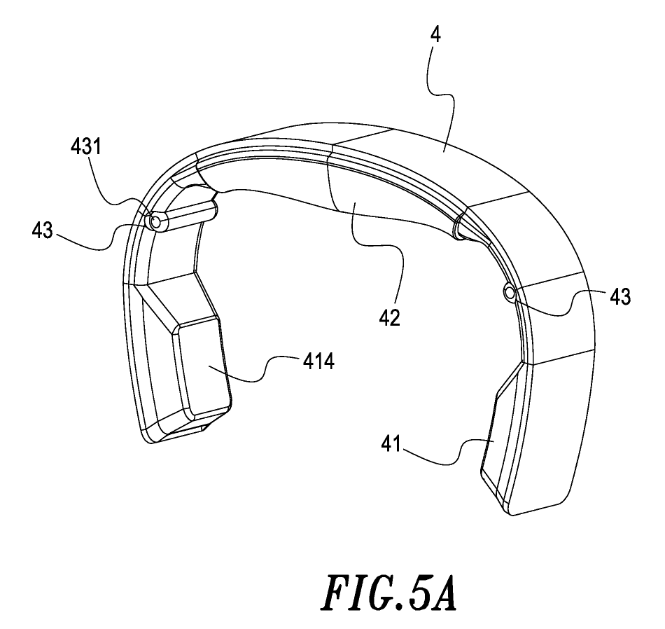

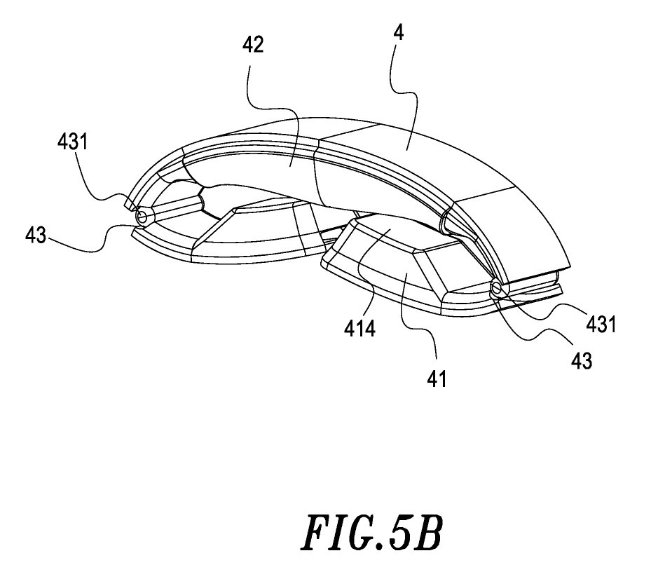

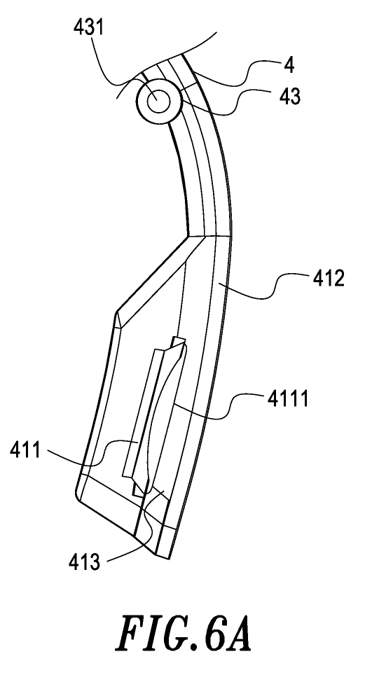

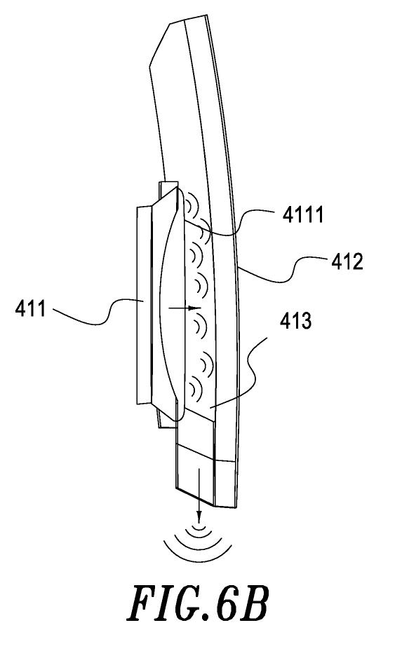

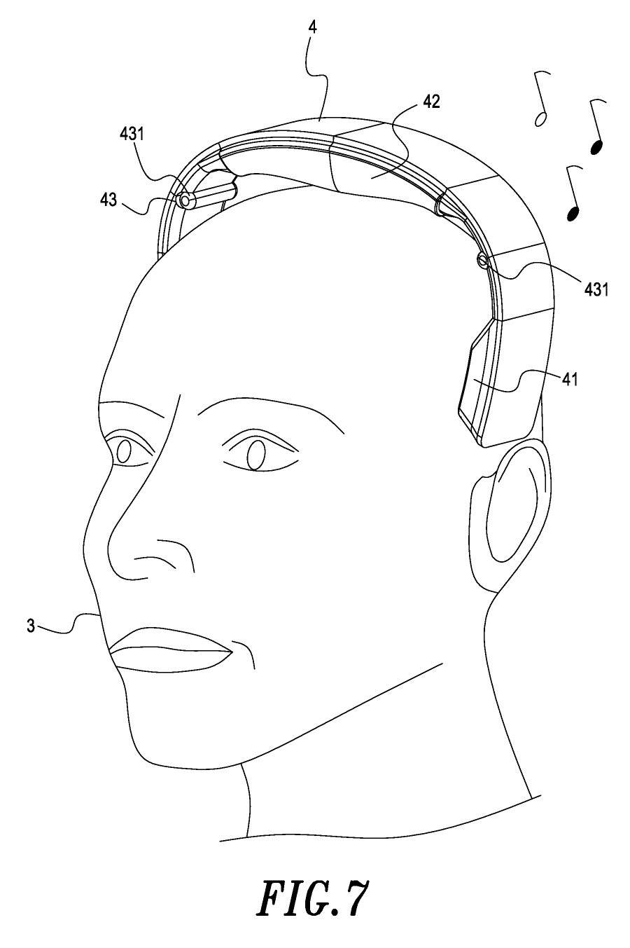

With references to FIG. 5A, FIG. 5B, FIG. 6A, FIG. 6B, and FIG. 7, showing the second preferred embodiment of the head multi-directional audio device of the present invention, including a schematic 3-D structural view, a schematic 3-D folding view, a schematic cross view of a broadcasting device, a schematic sounding view of the broadcasting device, and a schematic application view. As shown in figures, the head multi-directional audio device includes:

a head-wear member 4, which has two broadcasting devices 41, one buffer structure 42 and two folding portions 43, the two broadcasting devices 41 are with two sounding portions 4111 at the two external sides thereof, the two broadcasting devices 41 are extended toward the right hand side and left hand side of the head-wear member 4 individually and are bent inwardly, each sounding portion 4111 has a baffle structure 412 thereon, at least one sound exit 413 is between the sounding portion 4111 and the baffle structure 412. Thus the sound from the sounding portion 4111 can be downwardly reflected to the sound exit 413 by the baffle structure 412.
While the user 3 wears the head multi-directional audio device (above his ears), the sound from the two sounding portions 4111 is reflected to the sound exits 413 by the baffle structures 412 so as to spread the sound to the surrounding via the sound exits 413. So that the user 3 can hear the sound from the two sounding portions 4111 of speakers 411 of the broadcasting devices 41 even if the two sounding portions 4111 are not toward the ears of the user 3.

Preferably, the folding portion 43 has a pivot 431 inside in order to let the broadcasting device 41, extended from the head-wear member 4, be bent and adjusted angle inwardly, and the head multi-directional audio device with a function of completely and inwardly bending can be disposed on a surface.

Preferably, the buffer structure 42 is able to accommodate a PCB and batteries (not shown in figure), the PCB and batteries are electrically connected with the broadcasting device 41.

Preferably, the buffer structure 42 is made of rubber material in order to let the user comfortably wear the head multi-directional audio device.

Preferably, the broadcasting device 41 has at least one speaker 411 inside.

Preferably, the broadcasting device 41 has a cushion portion 414 inwardly so as to make the broadcasting devices 41 be fit onto the side surface of the head of the user 3, and the cushion portion 414 is made of rubber material.

Preferably, the surface of the head-wear member 4 can be added a metal case (not shown in figure).

Compared with prior arts, the head multi-directional audio device of the present invention has advantages listed below:

1. The head multi-directional audio device is able to let sound be broadcasted outwardly so as to avoid the user not concentrating his mind due to a headset.
2. The head multi-directional audio device is able to let sound be broadcasted outwardly so as to make a low possibility of damaging the ears of the user.

Although the invention has been disclosed and illustrated with reference to particular embodiments, the principles involved are susceptible for use in numerous other embodiments that will be apparent to persons skilled in the art. This invention is, therefore, to be limited only as indicated by the scope of the appended claims

What is claimed is:

1. A head multi-directional audio device comprising:
a head-wear member 1, having two broadcasting devices 11, one buffer structure 12 and two folding portions 13, the two broadcasting devices 11 being with two sounding portions 1111 at the two external sides thereof, the two broadcasting devices 11 being extended toward the right hand side and left hand side of the head-wear member 1 individually; and two shelters 2, each having at least two braces 21 that are to support the shelter 2 on the two sounding portions 1111, at least one sound exit 23 being between two braces 21 on the each sounding portion 1111.

2. The head multi-directional audio device according to claim 1, wherein the folding portion 13 has a pivot 131 inside in order to let the broadcasting device 11, extended from the head-wear member 1, be bent an angle inwardly.

3. The head multi-directional audio device according to claim 1, wherein the buffer structure 12 is able to accommodate a PCB and batteries, the PCB and batteries are electrically connected with the broadcasting device 11.

4. The head multi-directional audio device according to claim 1, wherein the buffer structure 12 is made of rubber material.

5. The head multi-directional audio device according to claim 1, wherein the broadcasting device 11 has at least one speaker 111 inside.

6. The head multi-directional audio device according to claim 1, wherein the broadcasting device 11 has a cushion portion 112 inwardly.

7. The head multi-directional audio device according to claim 6, wherein the cushion portion 112 is made of rubber material.

8. The head multi-directional audio device according to claim 1, wherein the surface of the head-wear member 1 is added a metal case.

9. The head multi-directional audio device according to claim 1, wherein the surface of the broadcasting device 11 is added a metal case.

10. A head multi-directional audio device comprising:
a head-wear member 4, having two broadcasting devices 41, one buffer structure 42 and two folding portions 43, the two broadcasting devices 41 being with two sounding portions 4111 at the two external sides thereof, the two broadcasting devices 41 being extended toward the right hand side and left hand side of the head-wear member 4 individually, each sounding portion 4111 having a baffle structure 412 thereon, at least one sound exit 413 being between the sounding portion 4111 and the baffle structure 412.

11. The head multi-directional audio device according to claim 10, wherein the folding portion 43 has a pivot 431 inside in order to let the broadcasting device 41, extended from the head-wear member 4, be bent and adjust angle inwardly.

12. The head multi-directional audio device according to claim 10, wherein the buffer structure 42 is able to accommodate a PCB and batteries, the PCB and batteries are electrically connected with the broadcasting device 41.

13. The head multi-directional audio device according to claim 10, wherein the buffer structure 42 is made of rubber material.

14. The head multi-directional audio device according to claim 10, wherein the broadcasting device 41 has at least one speaker 411 inside.

15. The head multi-directional audio device according to claim 10, wherein the broadcasting device 41 has a cushion portion 414 inwardly.

16. The head multi-directional audio device according to claim 15, wherein the cushion portion 414 is made of rubber material.

17. The head multi-directional audio device according to claim 10, wherein the surface of the head-wear member 4 can be added a metal case.

18. The head multi-directional audio device according to claim 10, wherein the surface of the broadcasting device 41 can be added a metal case.
